(19) United States
(12) Patent Application Publication
(10) Pub. No.: US 2005/0170153 A1
(43) Pub. Date: Aug. 4, 2005

(54) Printable thin microporous membrane

(75) Inventors: Eric H. Miller, Philpot, KY (US); Mark T. DeMeuse, Charlotte, NC (US); Paul A. Peterson, Lake Wylie, SC (US); Tim W. Martin, Charlotte, NC (US)

Correspondence Address: ROBERT H. HAMMER III, P.C., 3121 SPRINGBANK LANE, SUITE I, CHARLOTTE, NC, 28226, US

(73) Assignee: Celgard Inc.

(21) Appl. No.: 10/770,302

(22) Filed: Feb. 2, 2004

(51) Int. Cl. B41M 5/00

(52) U.S. Cl. 428/195.1

(57) ABSTRACT

The instant invention provides a printable thin microporous membrane. The printable thin microporous membrane includes a thin microporous membrane, and a printing ink on the thin microporous membrane. The membrane has a thickness in the range of 8μ to 50μ, a Gurley permeability in the range of 5 to 100 seconds/10 cc, and an average porosity in the range of 30% to 60%.

### FIELD OF INVENTION

The instant invention relates to a printable thin microporous membrane.

### BACKGROUND OF THE INVENTION

Polyolefins enjoy a widespread use in today's world. Many applications of polyolefins require good adhesion to other materials—examples include adhesive bonding, lamination, painting, printing, coating, and metallizing. Unfortunately, the surface properties of polyolefins are not conducive to adhesion. The surface properties of polyolefins are not conducive to adhesion because polyolefins have very poor bonding properties.

A variety of pretreatments and primers has been developed for altering the surface properties of polyolefins to enhance adhesion. These include corona discharge, flame and low-pressure plasma treatment for plastics, and the use of a chlorine donor for elastomers. Each method has advantages and disadvantages.

There are many advantages in using a thin microporous membrane; these advantages include, but are not limited to, elimination of the need for pretreatment of polyolefins, ability to utilize a wide range of printing inks, ability to dry the printing rapidly, and ability to create sharper images.

U.S. Pat. No. 4,861,644 discloses a microporous material substrate, which comprises a matrix consisting essentially of linear ultrahigh molecular weight polyolefin, a large proportion of finely divided water-insoluble siliceous filler, and interconnecting pores, which may be printed with printing ink.

Polyolefin films are often used in packaging applications. For example, oriented polypropylene (“OPP”), specifically, monolayer OPP is not printable. To make OPP printable, it must be treated. One treatment is to co-extrude a polypropylene/polyethylene (“PP-PE”) film. One such film is commercially available from AET, Inc. of Wilmington, Del. It is a 0.48 mil (12μ) PP-PE printable film.

Printing processes, printing equipment, and printing inks have been extensively discussed and documented. Examples of reference works that may be consulted include L. M. Larsen, Industrial Printing Ink, Reinhold Publishing Corp., (1962); Kirk-Othmer, Encyclopedia of Chemical Technology, 2d Ed., John Wiley & Sons, Inc., Vol. 11, pages 611-632 (1966) and Vol. 16, pages 494-546 (1968); and R. N. Blair, The Lithographers Manual, The Graphic Arts Technical Foundation, Inc., 7th Ed. (1983).

However, there is still a need for improving the application of printing inks to polyolefins. The instant invention provides a printable thin microporous membrane. Furthermore, the instant invention facilitates the production of large volumes of printed thin microporous membranes at a commercial speed.

### SUMMARY OF THE INVENTION

The instant invention is a printable thin microporous membrane. The printable thin microporous membrane includes a thin microporous membrane, and a printing ink on the thin microporous membrane. The membrane has a thickness in the range of 8μ to 50μ, a Gurley permeability in the range of 5 to 100 seconds/10 cc, and an average porosity in the range of 30% to 60%.

### DETAILED DESCRIPTION OF THE INVENTION

The instant invention is a printable thin microporous membrane. The printable thin microporous membrane includes a thin microporous membrane, and a printing ink on the membrane.

The thin microporous membrane can be made of synthetic polymers, cellulose, or synthetically modified cellulose. Synthetic polymers include, but are not limited to, polyethylene, polypropylene, polybutylene, poly (isobutylene), poly (methyl pentene), polysulfone, polyethersulfone, polyester, polyetherimide, polyacrylnitril, polyamide, polymethylmethacrylate (PMMA), polystyrene, polyvinyl chloride, ethylenevinyl alcohol, and fluorinated polyolefins. Preferably, the thin microporous membrane is made of polyolefin such as polypropylene and polyethylene. Most preferably, the thin microporous membrane is made of polypropylene.

The thin microporous membrane has a thickness in the range of 8μ to 50μ. Preferably, the membrane has a thickness of 25μ or less. Furthermore, the membrane has a Gurley permeability in the range of 5 to 100 seconds/10 cc, and an average porosity in the range of 30% to 60%. The membrane has an average pore size in the range of (0.2μ×0.02μ) to (0.2μ×0.15μ). The porosity is quintessential to the instant invention because the pores contribute whiteness and opaque traits to the membrane.

In addition, the thin microporous membrane has a machine direction tensile strength in the range of 15 kpsi to 19 kpsi, and a transverse direction tensile strength of 1.2 kpsi to 2.2 kpsi. Machine direction tensile strength is also important to instant invention because high machine direction tensile strength provides good print registration.

More preferably, the printable membrane comprises a single layer microporous polypropylene membrane having a thickness of 8μ to 50μ; and most preferably, a thickness of 8μ to less than 12μ. One such membrane is commercially available from Celgard Inc. of Charlotte, N.C. Celgard, Inc. employs the Celgard® process to make one such membrane. In Celgard® process, which is comprised of a number of interrelated steps, polypropylene is extruded to form row lamellar microcrystalline, which is further consolidated by annealing, and then it is stretched to induce porosity. The induced pores are slitlike pores.

Thickness is determined according to Thickness Method T411 om-83, which was developed under the auspices of the Technical Association of the Pulp and Paper Industry, by using a precision micrometer with a ½ inch diameter, circular shoe contacting the sample at seven (7) PSI. Ten (10) individual micrometer readings taken across the width of the sample are averaged.

Gurley, according to ASTM-D726(B), is a resistance to air flow measured by the Gurley densometer. Gurley is the time in seconds required to pass 10 cc of air through one square inch of product under a pressure of 12.2 inches of water.

Porosity may be determined according to ASTM D-2873.

Both machine direction tensile strength and transverse direction tensile strength may be determined according to ASTM D-412-83. Machine direction tensile strength measures the tensile strength on the major axis, which is oriented along the length of the sheet, and the transverse direction tensile strength measures the tensile strength of the major axis, which is oriented across the sheet.

Different methods may be used to make the thin microporous membrane. One of the known processes broadly comprises the following steps: extruding a polymer to form a sheet; annealing the sheet; and stretching the annealed sheet (i.e. the dry stretched or Celgard® process). The methods to make thin microporous membrane include, but are not limited to, the method disclosed by the U.S. Pat. No. 6,132,654, which is incorporated herein by reference.

Thin microporous membranes may be printed with a wide variety of printing inks using a wide variety of printing processes. Both the printing inks and printing processes may themselves be conventional. Furthermore, a wide variety of prints may be printed on the thin microporous membrane, examples include, but are not limited to, patterns, designs, photographs, drawings, barcodes, words, ideas, concepts, logos, brands, trademarks, slogans, advertisings, instructions, and combinations thereof.

Thin microporous membrane possesses a natural capillary action, which allows the membrane to wick and trap the printing ink into its pores. Furthermore, the capillary action facilitates a higher degree of printing ink absorption; thus, prolonging the life of the print.

Printing ink includes, but is not limited to, lithographic printing ink, offset lithographic printing ink, aniline printing ink, oil-based printing ink, water-based printing ink, conductive printing ink, and letterpress printing ink.

U.S. Pat. No. 4,861,644, which is incorporated herein by reference, discloses different classes of printing processes. Different classes of printing processes included, but are not limited to, typographic printing, intaglio printing, planographic printing, stencil printing, ink jet printing, digital printing, and typewriting and dot matrix printing.

Typographic printing process is a process in which the ink is placed on macroscopically raised areas of the printing plate. Typographic printing process includes rubber stamp printing, letterpress printing, flexography, and letterset printing, which is also know as dry offset printing and as offset letterpress printing.

Intaglio printing, which is also known as gravure printing, is a process in which ink is placed on a depressed areas of the printing plate.

Planographic printing is a process in which ink is placed on localized regions of a printing plate that is either smooth or contains only microscopically raised areas. Planographic printing includes, but is not limited to, lithography, collotype printing, autotype printing, hectograph printing, and xerography. Lithography further includes, but is not limited to, direct lithography, and off set lithography. Conventional lithography uses oil-based inks while reverse lithography uses water-based inks. In direct lithography (whether conventional or reverse), printing ink is applied to the substrate directly from the lithographic printing plate. In offset lithography (whether conventional or reverse), the printing ink is transferred first from the lithographic printing plate to a printing blanket and then from the printing blanket to the substrate.

Digital printing utilizes toners in powder and liquid form, which fuse into the pores of the microporous membrane.

Preferably, the printing process is either flexography, lithography, or letterpress printing. Of the lithographic processes, offset lithography is preferred, especially when the lithography is conventional lithography. Most preferably, the printing process is flexography.

The thin microporous membrane may be suitable for line printing, halftone printing, and continuous tone printing.

A printing press may be utilized to produce large quantities of printed thin microporous membranes at a commercial speed. The three general types of printing presses commonly used for printing flat substrates are the platen press, the flatbed cylinder press, and the rotary press. The rotary press, which may be sheet fed or web fed, is most often used. Preferably, a flexographic press is utilized to produce printed thin microporous membrane at a commercial speed.

The present invention may be embodied in other forms without departing from the spirit and the essential attributes thereof, and, accordingly, reference should be made to the appended claims, rather than to the foregoing specification, as indicated the scope of the invention.

1. A printable microporous membrane comprising:
a thin microporous membrane, wherein said thin microporous membrane having a thickness in the range of 8μ to 50μ, a Gurley permeability in the range of 5 to 100 seconds/10 cc, and an average porosity in the range of 30% to 60%; and
printing ink on said thin microporous membrane.

2. The printable microporous membrane according to claim 1, wherein said membrane having a print selected from the group consisting of patterns, designs, photographs, drawings, barcodes, words, ideas, concepts, logos, brands, trademarks, slogans, advertisings, instructions, and combinations thereof.

3. The printable microporous membrane according to claim 1, wherein said microporous membrane further comprising a polyolefin.

4. The printable microporous membrane according to claim 3, wherein said polyolefin being a polypropylene.

5. The printable microporous membrane according to claim 1, wherein said microporous membrane having an average pore size in the range of (0.2μ×0.02μ) to (0.2μ×0.15μ).

6. The printable microporous membrane according to claim 1, wherein said microporous membrane further having a machine direction tensile strength in the range of 15 kpsi to 19 kpsi, and a transverse direction tensile strength in the range of 1.2 kpsi to 2.2 kpsi.

7. The printable microporous membrane according to claim 1, wherein said printing ink being selected from the group consisting of lithographic printing ink, offset lithographic printing ink, jet printing ink, aniline printing ink, oil-based printing ink, water-based printing ink, conductive printing ink, and letterpress printing ink.

8. A method for making a printed microporous membrane comprising the steps of:
providing a microporous membrane, wherein said microporous membrane having a thickness in the range of 8μ to 50μ, a Gurley permeability in the range of 5 to 100 seconds/10 cc, and an average porosity in the range of 30% to 60%;
providing a printing ink; and
printing said printing ink upon said microporous membrane.

9. The method for making a printed microporous membrane according to claim 8, wherein said printed microporous membrane having a print selected from the group consisting of patterns, designs, photographs, drawings, barcodes, words, ideas, concepts, logos, brands, trademarks, slogans, advertisings, instructions, and combinations thereof.

10. The method for making a printed microporous membrane according to claim 8, wherein said microporous membrane further comprising a polyolefin.

11. The method for making a printed microporous membrane according to claim 10, wherein said polyolefin being a polypropylene.

12. The method for making a printed microporous membrane according to claim 8, wherein said microporous membrane further having an average pore size in the range of (0.2μ×0.02μ) to (0.2μ×0.15μ).

13. The method for making a printed microporous membrane according to claim 8, wherein said microporous membrane further having a machine direction tensile strength in the range of 15 kpsi to 19 kpsi, and a transverse direction tensile strength in the range of 1.2 kpsi to 2.2 kpsi.

14. The method for making a printed microporous membrane according to claim 8, wherein said printing ink being selected from the group consisting of lithographic printing ink, offset lithographic printing ink, jet printing ink, aniline printing ink, oil-based printing ink, water-based printing ink, conductive printing ink, and letterpress printing ink.

15. The method for making a printed microporous membrane according to claim 8, wherein said printing step being a process selected from the group consisting of typographic printing, intaglio printing, planographic printing, stencil printing, ink jet printing, digital printing, and typewriting and dot matrix printing.

16. The method for making a printed microporous membrane according to claim 15, wherein said typographic printing being a process selected from the group consisting of rubber stamp printing, letterpress printing, flexography, and letterset printing.

17. The method for making a printed microporous membrane according to claim 15, wherein said planographic printing being a process selected from the group consisting of lithography, collotype printing, autotype printing, hectograph printing, and xerography.
